(19) United States
(12) Patent Application Publication
(10) Pub. No.: US 2013/0146405 A1
(43) Pub. Date: Jun. 13, 2013

(54) BRAKE DISK

(71) Applicants: Yoon Cheol KIM, Seoul (KR); Jae Young LEE, Yongin (KR); Seong Jin KIM, Yongin (KR); Jae Min HAN, Ansan (KR)

(72) Inventors: Yoon Cheol KIM, Seoul (KR); Jae Young LEE, Yongin (KR); Seong Jin KIM, Yongin (KR); Jae Min HAN, Ansan (KR)

(73) Assignees: KIA MOTORS CORPORATION, Seoul (KR); HYUNDAI MOTOR COMPANY, Seoul (KR)

(21) Appl. No.: 13/547,483

(22) Filed: Jul. 12, 2012

(30) Foreign Application Priority Data
Dec. 8, 2011 (KR) 10-2011-0130848

(51) Int. Cl. F16D 65/12

(52) U.S. Cl. 188/218 XL

(57) ABSTRACT

Disclosed herein is a brake disk. More specifically, the brake disk includes a friction part, a hat part and a plurality of fasteners. The friction part includes a coupling aperture formed at a center thereof, a coupling portion formed along an inner side of the coupling aperture to have a predetermined thickness and a plurality of connecting bores formed in the coupling portion so that the connecting bores are spaced apart from each other and located along a circumference of the coupling portion. The hat part is inserted into the coupling aperture of the friction part and includes a coupling flange corresponding to the coupling portion of the friction part. The coupling flange includes a plurality of connecting bores that correspond to the plurality of connecting apertures. The plurality of fasteners are each horizontally inserted into the connecting apertures and bores to couple the friction part with the hat part.

### CROSS-REFERENCE TO RELATED APPLICATIONS

The present application claims priority to Korean Patent Application No. 10-2011-0130848 filed on Dec. 8, 2011, the entire contents of which is incorporated herein for purposes by this reference.

### BACKGROUND

1. Technical Field

The present invention relates to a brake disk used in an automobile braking system.

2. Description of the Related Art

Owing to problems of insufficient petroleum energy and climate change, automobile companies all over the world have made significant efforts to develop technologies for improving the ratio of travel distance to fuel consumption. Particularly, technologies for reducing the weight of a vehicle without deteriorating performance have received considerable attention as for a way of improving the ratio of travel distance to fuel consumption.

In particular, reducing the weight of a lower part of a vehicle directly influences the performance of a vehicle and the ratio of travel distance to fuel consumption of a vehicle as a result. In this case, since the reduction of the unsprung mass is directly related to a wheel drive load and effectively improves the ratio of travel distance to fuel consumption, technologies related thereto have begun to advance rapidly.

Among such technologies, a technology for manufacturing a brake disk by mixing aluminum with gray cast iron is receiving considerable attention as a way to reduce the weight of a vehicle without deteriorating the performance of a brake disk which accounts for the majority of unsprung mass.

As shown in FIG. 1, a conventional brake disk 10 includes a hat part 30 to be mounted on a hub, and a disk plate 20 causing friction during braking. Here, both the hat part 30 and the disk plate 20 are made of gray cast iron which is a material having a plate-like graphite structure and exhibiting excellent braking characteristics such as vibration attenuation, damping, heat radiation, lubrication and the like.

However, gray cast iron is heavy because the specific gravity thereof is about 7.2 g/cm³. Therefore, gray cast iron is a major factor that causes a drop in the ratio of travel distance to fuel consumption of a vehicle.

Accordingly, in order to overcome such a problem, it is necessary to develop a lighter disk brake alternative. Moreover, the developed brake disk must satisfy performance requirements such as durability, radiation performance, deformation resistance and the like.

It is to be understood that the foregoing description is provided to merely aid the understanding of the present invention, and does not mean that the present invention falls under the purview of the related art which was already known to those skilled in the art.

### SUMMARY

Accordingly, the present invention has been devised to solve the above-mentioned problems, and an object of the present invention is to provide a brake disk, which can prevent stress from concentrating on the coupling portion thereof and can improve a heat radiation effect by coupling brake disk elements using a horizontal bolt type fastener.

In order to accomplish the above object, an aspect of the present invention provides a brake disk, including: a friction part which includes a coupling aperture formed at a center thereof, a coupling portion formed along an inner side of the coupling aperture to have a predetermined thickness and a plurality of connecting bores formed in the coupling portion so that they are spaced apart from each other and located along the circumference of the coupling portion; a hat part which is inserted in the coupling aperture of the friction part and which includes a coupling flange corresponding to the coupling portion of the friction part, the coupling flange being provided with a plurality of connecting apertures communicating with the plurality of connecting bores; and a plurality of fasteners, each of which is horizontally inserted into the connecting bores and apertures to couple the friction part with the hat part.

In the brake disk, an outer circumference of the connecting flange of the hat part is smaller than an inner circumference of the coupling portion of the friction part, so that the friction part and the hat part are spaced apart from each other by a predetermined distance and a gap is formed therebetween when they are coupled with each other, so that heat may be discharged to the outside through the gap.

Further, the coupling flange of the hat part may be vertically tapered, and a plurality of the coupling flanges may be formed along a circumference of the hat part, and each of the coupling flanges may be provided with a connecting aperture. The fastener may be sequentially to inserted into the connecting bore and the connecting aperture from an inside of the hat part and fastened thereto. This fastener may be a bolt, and the bolt may be fastened in the hat part with a head thereof positioned inside the hat part.

Further, the friction part may be made of gray cast iron including iron as a main component, 3.0-3.8 wt % of carbon, 1.0-2.8 wt % of silicon, 1.0 wt % or less of manganese (0 wt %: none), 0.2 wt % or less of phosphorus (0 wt %: none), 0.15 wt % or less of sulfur (0 wt %: none), and inevitable impurities.

Further, the hat part may be made of an aluminum alloy including aluminum as a main component, 0.1 wt % or less of copper (0 wt %: none), 1.3 wt % or less of silicon (0 wt %: none), 0.6-3.0 wt % of magnesium, 0.25 wt % or less of zinc (0 wt %: none), 0.5 wt % or less of iron (0 wt %: none), 1.0 wt % or less of manganese (0 wt %: none), 0.35 wt % or less of chromium (0 wt %: none), and inevitable impurities.

Further, the fastener may be made of an iron alloy including iron as a main component, 0.38 wt % or less of carbon (0 wt %: none), 0.24 wt % or less of silicon (0 wt %: none), 0.75 wt % or more of manganese, 0.011 wt % or less of phosphorus (0 wt %: none), 0.009 wt % or less of sulfur (0 wt %: none), 0.09 wt % or less of nickel (0 wt %: none), 1.1 wt % or less of chromium (0 wt %: none), 0.21 wt % or less of copper (0 wt %: none), 0.29 wt % or less of molybdenum (0 wt %: none), and inevitable impurities.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a conventional brake disk;

FIG. 2 is a plan view showing a brake disk according to an exemplary embodiment of the present invention;

FIG. 3 is a perspective view showing a friction part of the brake disk shown in FIG. 2;

FIG. 4 is a perspective view showing a hat part of the brake disk shown in FIG. 2;

FIG. 5 is a perspective view showing a fastener of the brake disk shown in FIG. 2; and

FIG. 6 is a sectional view showing the brake disk cut along the line A-A in FIG. 2.

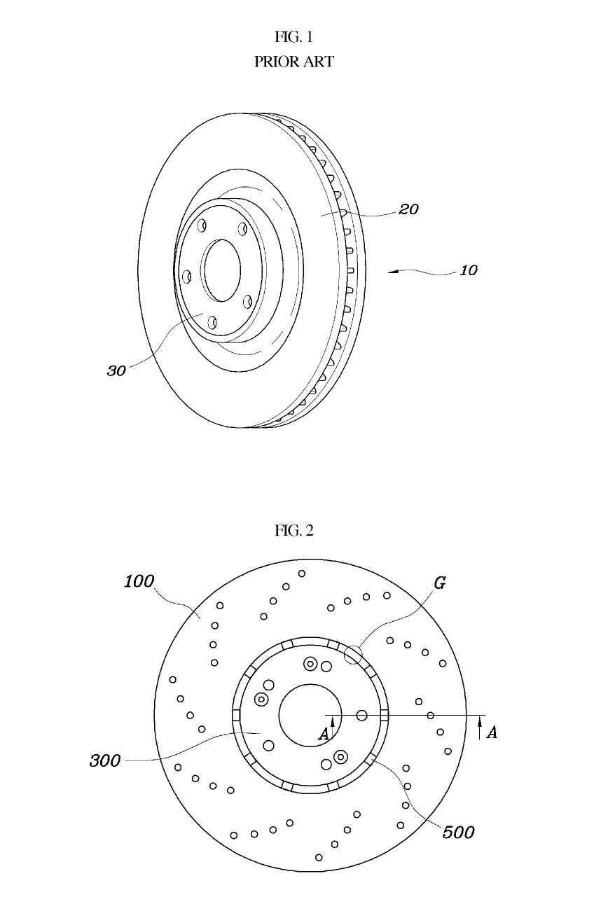

### DESCRIPTION OF THE PREFERRED EMBODIMENTS

Hereinafter, preferred embodiments of the present invention will be described in detail with reference to the attached drawings.

It is understood that the term “vehicle” or “vehicular” or other similar tem as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

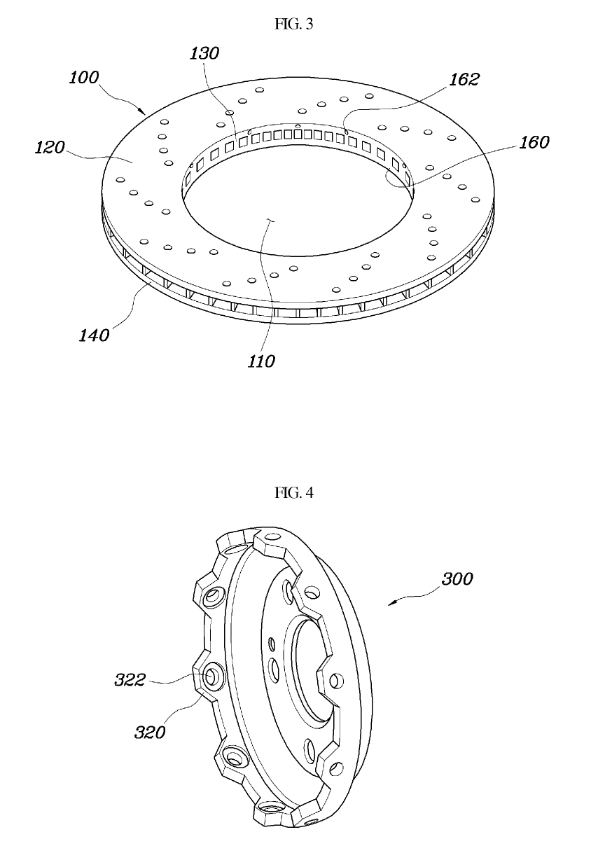

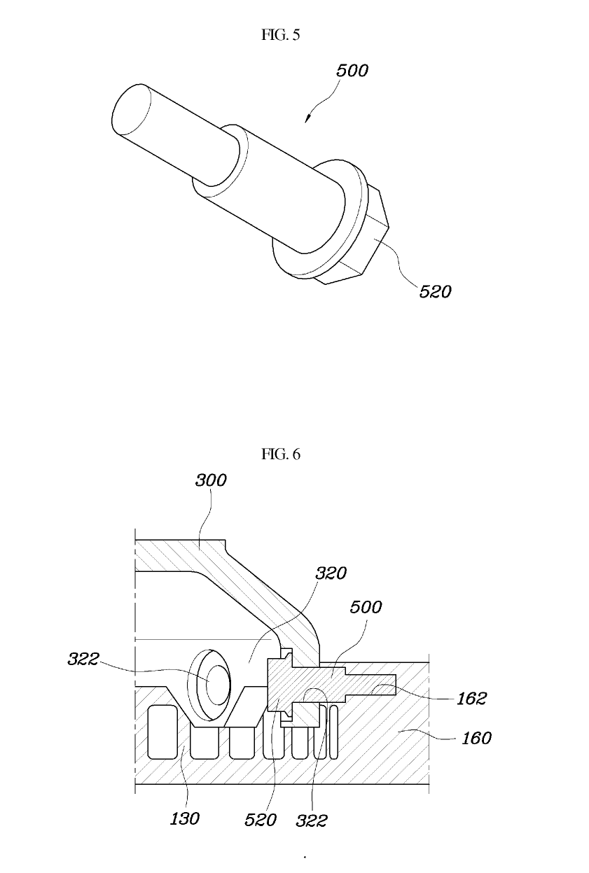

FIG. 2 is a plan view showing a brake disk according to an exemplary embodiment of the present invention, FIG. 3 is a perspective view showing a friction part of the brake disk shown in FIG. 2, FIG. 4 is a perspective view showing a hat part of the brake disk shown in FIG. 2, FIG. 5 is a perspective view showing a fastener of the brake disk shown in FIG. 2, and FIG. 6 is a sectional view showing the brake disk cut along the line A-A in FIG. 2.

The brake disk of the present invention includes: a friction part 100, a hat part 300 and a plurality of fasteners 500. More specifically, the friction part includes a coupling aperture 110 formed at a center thereof, a coupling portion 160 formed along the inner side of the coupling aperture 110 to have a predetermined thickness and a plurality of connecting bores 162 formed in the coupling portion 160 so that they are spaced apart from each other and located along the circumference of the coupling portion 160.

The hat part 300 is inserted into the coupling aperture 110 of the friction part 100 and includes a coupling flange 320 corresponding to the coupling portion 160 of the friction part 100. The coupling flange 320 is provided with a plurality of connecting apertures 322 communicating with the plurality of connecting bores 162. The plurality of fasteners 500 are each horizontally inserted into the connecting bores and apertures 162 and 322 to couple the friction part 100 with the hat part 300.

First, referring to FIG. 3, the friction part 100 includes a coupling aperture 110 formed at a center thereof, a coupling portion 160 formed along the inner side of the coupling aperture 110 to have a predetermined thickness and a plurality of connecting bores 162 formed in the coupling portion 160 such that they are spaced apart from each other and located along the circumference of the coupling portion 160. The drive shaft of a vehicle is connected to the brake disk through the coupling aperture 110, and the friction part 100 is provided with the coupling portion 160 having a predetermined thickness and located along the inner side of the coupling aperture 110.

More specifically, the friction part 100 includes an upper plate 120, a lower plate 140 and a plurality of ribs 130 disposed between the upper plate 120 and the lower plate 140 to form a heat radiation structure. That is, the coupling portion 160 of the friction part 100 includes the upper plate 120, the lower plate 140 and the ribs 130, and the plurality of connecting bores 162 are formed in the lateral inner side of the upper plate 120 (refer to FIGS. 3 and 6). Owing to such a configuration, the heat radiation structure formed between the upper and lower plates 120 and 140 of the friction part 100 is not blocked by the hat part 300, thus exhibiting sufficient radiation performance.

Meanwhile, FIG. 4 shows a hat part 300 of the brake disk shown in FIG. 2. As shown in FIG. 4, the hat part 300 is inserted in the coupling aperture 110 of the friction part 100, and includes a coupling flange 320 corresponding to the coupling portion 160 of the friction part 100. The coupling flange 320 is provided with a plurality of connecting apertures 322 corresponding to the plurality of connecting bores 162.

Further, FIG. 5 shows a fastener 500 of the brake disk shown in FIG. 2. The fastener 500 is horizontally inserted into the connecting bores and apertures 162 and 322 to couple the friction part 100 with the hat part 300. A plurality of fasteners 500 is provided.

Since the outer circumference of the connecting flange 320 of the hat part 300 is smaller than the inner circumference of the coupling portion 160 of the friction part 100, the friction part 100 and the hat part 300 are spaced apart from each other by a predetermined distance and thus, there is a gap (G) therebetween when they are coupled to each other, so that heat may be discharged to the outside through the gap (G).

As shown in FIG. 2, since the friction part 100 and the hat part 300 are spaced apart from each other by the predetermined distance, heat radiation can easily take place through the gap, and heat transfer caused by the difference in thermal conductivity between the friction part 100 and the hat part 300 can be prevented.

In some embodiments of the illustrative embodiment of the present invention, a bolt may be used as the fastener 500. The bolt may be fastened in the hat part 300 with a head 520 thereof, and the thickness of the bolt may change gradually. Therefore, as shown in FIG. 6, the fastener 500 is configured to be latched in the hat part 300, thus enabling the friction part 100 to be spaced apart from the hat part 300 by a constant distance.

Moreover, the coupling flange 320 of the hat part 300 is vertically tapered, and a plurality of the coupling flanges 320 may be formed along the circumference of the hat part 300. Each of the coupling flanges 320 is provided with a connecting aperture 322, respectively, and the fastener 500 is sequentially inserted into the connecting bore 162 and the connecting aperture 322, thus decreasing the number of components required and reducing the mass of the brake disk.

Meanwhile, the friction part 100 in the illustrative embodiment of the present invention is made of gray cast iron including iron as a main component, 3.0-3.8 wt % of carbon, 1.0-2.8 wt % of silicon, 1.0 wt % or less of manganese (0 wt %: none), 0.2 wt % or less of phosphorus (0 wt %: none), 0.15 wt % or less of sulfur (0 wt %: none), and inevitable impurities. Alternatively, the friction part 100 may be made of any material that has a strong resistance to frictional damage.

Further, the hat part 300 in the illustrative embodiment of the present invention is made of an aluminum alloy including aluminum as a main component, 0.1 wt % or less of copper (0 wt %: none), 1.3 wt % or less of silicon (0 wt %: none), 0.6-3.0 wt % of magnesium, 0.25 wt % or less of zinc (0 wt %: none), 0.5 wt % or less of iron (0 wt %: none), 1.0 wt % or less of manganese (0 wt %: none), 0.35 wt % or less of chromium (0 wt %: none), and inevitable impurities. That is, since the hat part 300 is made of a very stretchable material, it can be machined to a minimum using forging.

Meanwhile, the fastener 500 is made of an iron alloy including iron as a main component, 0.38 wt % or less of carbon (0 wt %: none), 0.24 wt % or less of silicon (0 wt %: none), 0.75 wt % or more of manganese, 0.011 wt % or less of phosphorus (0 wt %: none), 0.009 wt % or less of sulfur (0 wt %: none), 0.09 wt % or less of nickel (0 wt %: none), 1.1 wt % or less of chromium (0 wt %: none), 0.21 wt % or less of copper (0 wt %: none), 0.29 wt % or less of molybdenum (0 wt %: none), and inevitable impurities. This fastener 500 may be plated with chromium and nickel to prevent thermal expansion and corrosion from weakening the fastening force in a radial direction.

Advantageously, the weight of the above described brake disk can be reduced at a ratio of about 2 kg per disk while maintaining the same if not better braking characteristics of a conventional brake disk made of only gray cast iron. Further, although this brake disk is made of different materials (aluminum and gray cast iron), the present invention has sufficient strength to resist the maximum braking torque required because it is securely fastened by a high-tension bolt. Furthermore, since this disk brake resists thermal deformation, an advantage of this disk brake is that its thermal deformation is superior to that of a conventional brake disk made of only gray cast iron.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A brake disk, comprising:
a friction part including a coupling aperture formed at a center thereof, a coupling portion formed along an inner side of the coupling aperture to have a predetermined thickness and a plurality of connecting bores formed in the coupling portion so that they are spaced apart from each other and located along a circumference of the coupling portion;
a hat part inserted in the coupling aperture of the friction part and including a coupling flange corresponding to the coupling portion of the friction part, the coupling flange having a plurality of connecting apertures corresponding to the plurality of connecting bores in the friction part; and
a plurality of fasteners, each of which is horizontally inserted into the connecting bores and corresponding connecting apertures to couple the friction part with the hat part.

2. The brake disk according to claim 1, wherein an outer circumference of the connecting flange of the hat part is smaller than an inner circumference of the coupling portion of the friction part, so that the friction part and the hat part are spaced apart from each other by a predetermined distance and a gap is formed therebetween when they are coupled with each other, so that heat may be discharged to the outside through the gap.

3. The brake disk according to claim 1, wherein the coupling flange of the hat part is vertically tapered, and a plurality of the coupling flanges is formed along a circumference of the hat part, and each of the coupling flanges is provided with a connecting aperture.

4. The brake disk according to claim 1, wherein the fastener is sequentially inserted into the connecting bore and the connecting aperture from an inside of the hat part and fastened thereto.

5. The brake disk according to claim 1, wherein the fastener is a bolt, and the bolt is fastened in the hat part with a head thereof positioned inside the hat part.

6. The brake disk according to claim 1, wherein the friction part is made of gray cast iron including iron as a main component, 3.0-3.8 wt % of carbon, 1.0-2.8 wt % of silicon, 1.0 wt % or less of manganese (0 wt %: none), 0.2 wt % or less of phosphorus (0 wt %: none), 0.15 wt % or less of sulfur (0 wt %: none), and inevitable impurities.

7. The brake disk according to claim 1, wherein the hat part is made of an aluminum alloy including aluminum as a main component, 0.1 wt % or less of copper (0 wt %: none), 1.3 wt % or less of silicon (0 wt %: none), 0.6-3.0 wt % of magnesium, 0.25 wt % or less of zinc (0 wt %:
none), 0.5 wt % or less of iron (0 wt %: none), 1.0 wt % or less of manganese (0 wt %: none), 0.35 wt % or less of chromium (0 wt %: none), and inevitable impurities.

8. The brake disk according to claim 1, wherein the fastener is made of an iron alloy including iron as a main component, 0.38 wt % or less of carbon (0 wt %: none), 0.24 wt % or less of silicon (0 wt %: none), 0.75 wt % or more of manganese, 0.011 wt % or less of phosphorus (0 wt %:
none), 0.009 wt % or less of sulfur (0 wt %: none), 0.09 wt % or less of nickel (0 wt %: none), 1.1 wt % or less of chromium (0 wt %: none), 0.21 wt % or less of copper (0 wt %: none), 0.29 wt % or less of molybdenum (0 wt %: none), and inevitable impurities.
